(19) United States
(12) Patent Application Publication
(10) Pub. No.: US 2010/0115972 A1
(43) Pub. Date: May 13, 2010

(54) REFRIGERATOR AND CONTROL METHOD OF THE SAME

(76) Inventors: Soo Kwan Lee, Seoul (KR); Jun Ho Bae, Seoul (KR); Chang Joon Kim, Seoul (KR)

Correspondence Address: KED & ASSOCIATES, LLP, P.O. Box 221200, Chantilly, VA, 20153-1200, US

(21) Appl. No.: 12/593,104

(22) PCT Filed: Mar. 27, 2008
(86) PCT No.: PCT/KR08/01706

§ 371 Date: Sep. 25, 2009

(30) Foreign Application Priority Data
Mar. 30, 2007 (KR) 10-2007-0031622

(51) Int. Cl. F25D 17/06; F25D 13/00; F25B 39/02; G05B 15/00

(52) U.S. Cl. 62/89; 62/440; 62/419; 62/515; 700/275

(57) ABSTRACT

A refrigerator that is capable of achieving smooth flow of cool air therein and improving cooling efficiency of a cooled evaporator (10) and a control method of the same that is capable of controlling operation time of an evaporator (10) and a fan (20), thereby improving cooling efficiency of the refrigerator are disclosed.

### TECHNICAL FIELD

The present invention relates to a refrigerator and a control method of the same, and more particularly, to a refrigerator that is capable of achieving smooth flow of cool air therein and improving cooling efficiency of a cooled evaporator and a control method of the same that is capable of controlling operation time of an evaporator and a fan, thereby improving cooling efficiency of the refrigerator.

### BACKGROUND ART

Generally, a refrigerator is a freezing and refrigerating apparatus that repeatedly performs a refrigeration cycle in which refrigerant is compressed, condensed, expanded, and evaporated, for cooling the interior of the refrigerator to keep food fresh for a long time. A method of cooling a conventional refrigerator including a compressor for compressing low-temperature and low-pressure refrigerant into high-temperature and high-pressure refrigerant and an evaporator for performing heat exchange between the refrigerant, passing through the compressor, and external air, to perform the refrigeration cycle of the refrigerator will be described hereinafter with reference to FIGS. 1 and 2.

A refrigerator may be generally constructed in a structure in which a storage space performing a freezing function and a storage space performing a refrigerating function are divided from each other. Also, the refrigerator may be constricted in a cooling structure in which a single cooling apparatus, including an evaporator, is jointly used by both the freezing storage space and the refrigerating storage space or in another cooling structure in which two cooling apparatuses are separately provided to cool the refrigerating storage space and the freezing storage space, respectively. In the following, an example will be described in which a cooling apparatus is used to cool either the refrigerating storage space or the freezing storage space.

As shown in FIGS. 1 and 2, when a compressor 50 mounted in a refrigerator body is driven to compress gas refrigerant, the compressed gas refrigerant is condensed by a condenser, with the result that the temperature of the gas refrigerant lowers. After passing through the condenser, the gas refrigerant changes into low-temperature and low-pressure liquid refrigerant. After passing through an evaporator 10, the liquid refrigerant changes into low-temperature and low-pressure gas refrigerant. This is achieved by evaporation in which the refrigerant, flowing in the evaporator 10, takes heat away from air flowing around the evaporator 10, whereby the refrigerant is evaporated.

The air cooled by the evaporation is discharged into storage chambers 40 through a first communication port 34 formed at the upper part of a duct 30. The discharged cooled air cools the storage chambers 40 and is then introduced into the duct 30 through a second communication port 32 formed at the lower part of the duct 30. The temperature in the upper part of the refrigerator is higher than that in the lower part of the refrigerator due to the difference in density of air based on the temperature of air in the storage chambers 40. Consequently, the second communication port 32, through which air to be heat-exchanged by the evaporator 10 is introduced, is located at a relatively high position. Also, the first communication port 34, through which air introduced through the second communication port 32 and cooled by the evaporator 10 is discharged, is located at a position higher than the second communication port 32.

However, the above-described structure of the duct 30 has the following problem. Cool air, generated through heat exchange by the evaporator 10, does not flow in the refrigerator by convection, but flows in a circulation structure in which the cool air introduced through the second communication port 32 and discharged through the first communication port 34.

However, such a circulation structure has a problem in that air circulation is induced only around the upper storage chamber 40, whereby food in the storage chambers is not uniformly cooled. This local convection phenomenon increases the difference of temperature between the storage chambers. Furthermore, when the evaporator 10 or the compressor 50 is stopped, a cool air descending phenomenon occurs in which cool air gathers in the lower storage chamber 40, which is located at the lower part of the refrigerator. In addition, the temperature of air in the upper storage chamber 40 increases. As a result, the difference of temperature between the storage chambers increases.

### DISCLOSURE OF INVENTION

### Technical Problem

An object of the present invention devised to solve the problem lies on a refrigerator and a control method of the same that is capable of achieving the circulation of air cooled by an evaporator throughout the refrigerator, thereby improving cooling efficiency.

### Technical Solution

The object of the present invention can be achieved by providing a refrigerator including a storage chamber having a storage space defined therein, a duct partitioned from the storage chamber, the duct being provided at the upper part thereof with a first communication port communicating with the storage chamber, the duct being provided at the lower part thereof with a second communication port communicating with the storage chamber, an evaporator mounted in the duct, a fan mounted in the duct for blowing air from the duct into the storage chamber through the first communication port, and a controller for controlling the operation of the evaporator and the fan.

Preferably, the fan is configured such that the operation speed of the fan is controllable.

Preferably, the controller controls the fan to be kept operated for a predetermine time even after the evaporator is stopped.

Preferably, the controller controls the fan to be operated until the temperature of the evaporator reaches that of the air in the storage chamber.

In another aspect of the present invention, provided herein is a control method of a refrigerator, including a main cooling process of opening an evaporator and a fan to blow air in a duct into a storage chamber and cool the interior of the storage chamber and a sub cooling process of further operating the fan for a predetermined time, such that the remaining cool air in the evaporator and the duct is introduced into the storage chamber, after the operation of the evaporator is stopped.

Preferably, the sub cooling process includes a temperature comparison process of determining whether the temperature of the evaporator is equal to the temperature of air surrounding the evaporator and a fan stopping process of stopping the fan when it is determined at the temperature comparison process that the temperature of the evaporator is equal to the temperature of air surrounding the evaporator.

### Advantageous Effects

In the refrigerator and the control method of the same according to the present invention, the circulation of air cooled by the evaporator is achieved throughout the refrigerator. Consequently, it is possible to reduce the difference of temperature between the storage chambers. Also, the fan is kept operated for a predetermined time, although the evaporator is stopped. Consequently, it is possible to improve cooling efficiency.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIGS. 1 and 2 are sectional views illustrating the structure of a conventional refrigerator.

FIG. 3 is a front sectional view illustrating a refrigerator according to the present invention.

FIG. 4 is a side sectional view of the refrigerator according to the present invention.

FIG. 5 is a view illustrating the operation of a fan and a compressor in accordance with a control method of a refrigerator according to the present invention.

FIG. 6 is a flow chart illustrating processes of the control method of the refrigerator according to the present invention.

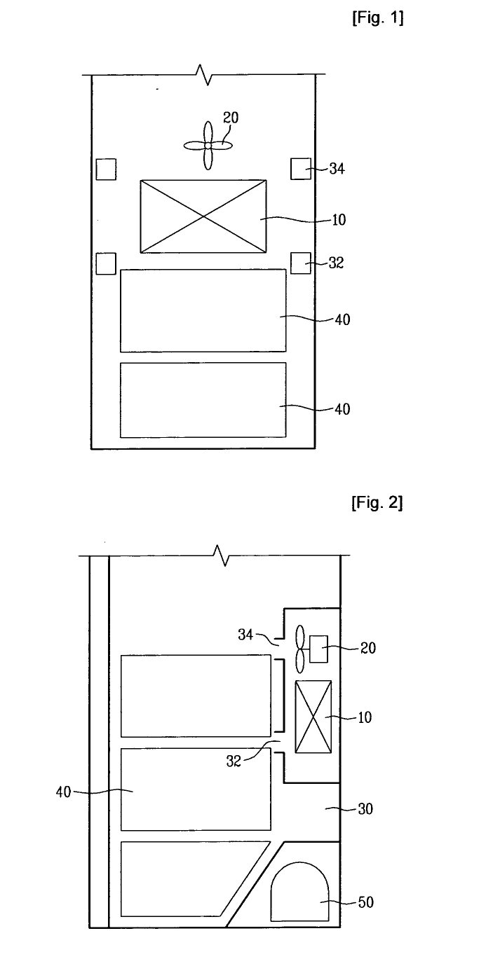

### MODE FOR THE INVENTION

Reference will now be made in detail to the preferred embodiments of the present invention, examples of which are illustrated in the accompanying drawings. However, the present invention is not limited to the illustrated embodiments but may be implemented in other forms. The illustrated embodiments are rather given in order that the disclosure of the present invention is thorough and perfect, and the concept of the present invention is sufficiently communicated to those skilled in the art to which the present invention pertains. Wherever possible, the same reference numbers will be used throughout the drawings to refer to the same or like parts.

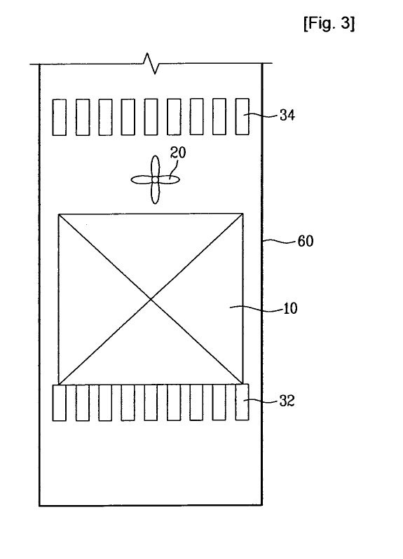

FIGS. 3 and 4 are front and side sectional views respectively illustrating a refrigerator according to the present invention. The refrigerator according to the present invention includes a plurality of storage chambers 40 each defining a storage space therein, a compressor 50 for compressing refrigerant, an evaporator 10 mounted in a duct 30 for performing heat exchange between the refrigerant compressed by the compressor 50 and air suctioned from the storage chambers through evaporation, and a fan 20 for blowing the heat-exchanged air such that the heat-exchanged air is discharged out of the duct, i.e., toward the storage chambers 40. The storage chambers 40, the compressor 50, the evaporator 10, and the fan 20 are mounted in a refrigerator body 60.

The storage chambers 40 are spaces partitioning the interior of the refrigerator. The number and size of the storage chambers 40 may be changed based on the size and use of the refrigerator. Also, although the respective storage chambers 40 are separated spaces in the refrigerator, air-flow holes (not shown) are formed at shelves of the respective storage chambers 40. Consequently, air in the storage chambers 40 can freely flow.

The duct 30 of the refrigerator according to the present invention has communication ports for suction and discharge of air in the storage chambers 40. Specifically, the duct 30 is provided at the upper part thereof with a first communication port 34. Also, the duct 30 is provided at the lower part thereof with a second communication port 32.

The first communication port 34 is a communication port through which air cooled by heat exchange of the evaporator 10 mounted in the duct 30 is discharged. The second communication port 32, located at the lower part of the duct 30, is a communication port through which air from the storage chambers is suctioned. Consequently, as shown in FIGS. 3 and 4, the duct of the refrigerator according to the present invention is constructed in a structure in which air is suctioned into the lower part of the duct, the air is cooled, and the cooled air is discharged from the upper part of the duct.

The suction of the air into the lower part of the duct and the discharge of the air from the upper part of the duct are possible by the directionality of the fan 20 mounted in the duct 30. When the fan 20 rotates in the forward direction, air is blown toward the first communication port 34. On the other hand, when the fan 20 rotates in the reverse direction, the flow direction of air is reversed.

Specifically, air flows in the refrigerator according to the present invention as follows. Air suctioned into the lower part of the duct 30 is cooled by the evaporator 10, and is then discharged into the upper storage chamber 40, which is located at the upper part of the refrigerator, by the fan 20. Due to the difference of density caused by the difference of temperature, the cool air flows to the lower storage chamber 40, which is located at the lower part of the refrigerator. The air, reaching the lower part of the refrigerator, is suctioned into the second communication port 32 formed at the lower part of the duct 30. This air circulation eliminates the cool air descending phenomenon, which occurs when the temperature at the lower part of the refrigerator is higher than that at the upper part of the refrigerator, thereby reducing the difference of temperature between the respective storage chambers 40 in the refrigerator.

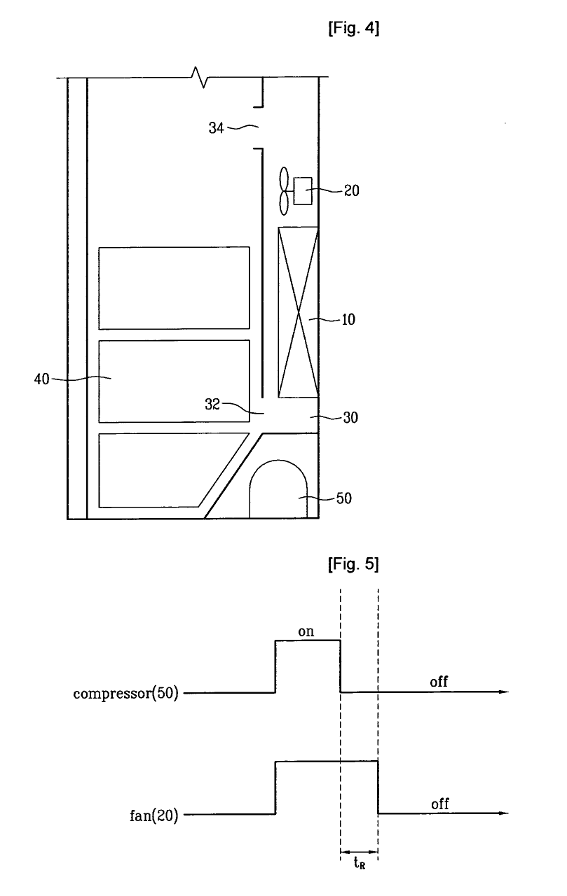

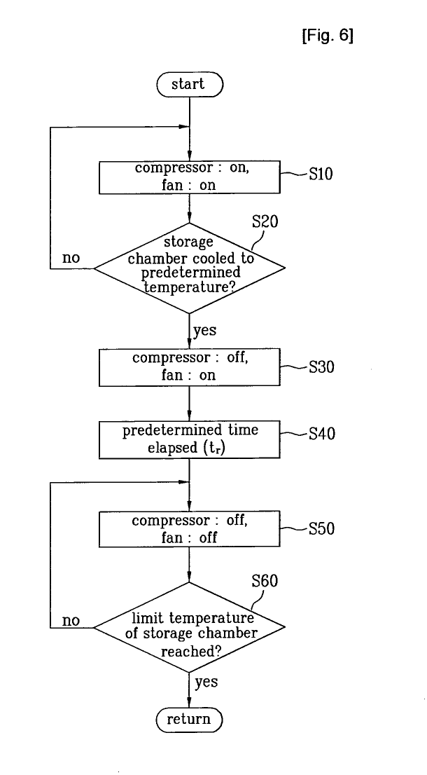

FIG. 5 is a graph illustrating operation time of the compressor 50 and the fan 20 in a control method of the refrigerator according to the present invention. The on-off operation for heat exchange by the evaporator 10 is not achieved by the operation of the evaporator 10 but may be decided based on the operation of the compressor that supplies refrigerant to be evaporated by the evaporator. That is, if the compressor 50 does not supply new refrigerant, the heat exchange capability of the evaporator gradually decreases. Consequently, the heat exchange operation by the evaporator 10 is assumed to be controlled by the on-off operation of the compressor 50.

The compressor 50 of the refrigerator does not continue to operate but is alternately turned on and off at predetermine time intervals. The on-off operation of the compressor 50 may be reserved at predetermined time intervals. Alternatively, the temperature of the storage chambers may be detected, and the compressor 50 may be operated only when the detected temperature is higher than a predetermined temperature. However, the latter method is more reasonable because the storage chambers are efficiently cooled depending upon kinds and amount of food in the storage chambers 40.

As shown in FIG. 5, the cooling of the storage chambers 40 of the refrigerator starts with the operation of the compressor 50 and the fan 20. The operation of the compressor 50 of the refrigerator means the heat exchange by the evaporator. Consequently, when the compressor 50 is operated, air in the storage chamber, the temperature of which increases, is forcibly blown to the evaporator by the fan 20, and the air is heat-exchanged by the evaporator, whereby the air is cooled.

In the control method of the refrigerator according to the present invention, the process of simultaneously operating the compressor 50 and the fan 20 is defined as a main cooling process. However, the power consumption of the compressor 50 is greater than that of the fan 20. This is because the compressor 50 is a component having the highest power consumption in consideration of characteristics of the refrigerator requiring to be continuously operated. Consequently, the operation of the compressor 50 is decided based on the temperature of the storage chambers in the refrigerator.

The evaporator 10, which evaporates the compressed refrigerant by heat exchange, is not supplied with new refrigerant necessary for heat exchange, when the operation of the compressor 50 is stopped. However, the temperature of the evaporator 10 is lower than the interior temperature of the storage chambers 40, and therefore, it is possible to utilize cooling performance of the evaporator 10 for a while.

In the control method of the refrigerator according to the present invention, therefore, as shown in FIG. 5, the fan 20 is kept operated for a predetermined time t_{R} although the operation of the compressor 50 is stopped. The process of operating the fan 20 although the operation of the compressor 50 is stopped is defined as a sub cooling process. Consequently, the control method of the refrigerator according to the present invention is characterized in that the cooling process includes the main cooling process of simultaneously operating the compressor 50 and the fan 20 and the sub cooling process of stopping the operation of the compressor 50 and operating the fan 20.

FIG. 6 is a flow chart illustrating the control method of the refrigerator according to the present invention.

The refrigerator starts to operate with the operation of the compressor 50 and the fan 20 (S10). By the operation of the compressor 50 and the fan 20, air suctioned into the duct 30 through the second communication port 32 formed at the duct 30 is heat-exchanged by the evaporator 10. The compressor 50 continues to compress refrigerant until the temperature of the storage chambers reaches a predetermined temperature Tₘᵢₙ. The temperature of the storage chambers may be measured by a temperature sensor mounted in a specific storage chamber 40. Alternatively, the average or maximum value of the temperature detected by a plurality of temperature sensors may be used. Consequently, when it is determined that the temperature T of the storage chambers reaches the predetermined temperature Tₘᵢₙ of the storage chambers, at a process of comparing the temperature T of the storage chambers with the predetermined temperature Tₘᵢₙ of the storage chambers (S20), the compressor 50 of the refrigerator stops the refrigerant compressing operation. However, the blowing operation of the fan 20 continues although the compression operation of the compressor 50 is stopped (S30). The comparison between the temperatures and the decision to operate the compressor 50 and the fan 20 are performed by a controller (not shown) of the refrigerator.

The subsequent process is a process of maintaining a state in which the operation of the compressor 50 is stopped and the fan 20 is operated for a predetermined time tᵣ (S40). After the state in which only the fan 20 is operated is maintained for the predetermined time tᵣ, the operation of the fan 20 is stopped (S50).

In another embodiment of the control method of the refrigerator according to the present invention, the predetermined time tᵣ may be time necessary to make the temperature of the evaporator 10 equal to the temperature of air in the storage chambers.

The reason why the compressor 50 and the fan 20 are simultaneously operated, and then only the fan 20 is operated while the operation of the compressor is stopped is that the temperature of the evaporator 10 is lower than that of the storage chambers, and therefore, the low temperature of the evaporator may be used to cool the storage chambers 40. However, when the temperature of the storage chambers 40 becomes equal to that of the evaporator 10, there is no reason why the air from the storage chambers 40 should be forwarded to the evaporator 10 by the fan 20. Consequently, when the temperature of the storage chambers 40 becomes equal to that of the evaporator 10, the operation of the fan 20 is stopped.

The process of operating only the fan 20 while stopping the operation of the compressor 50 as described above is the sub cooling process. When the operation of the fan 20 is stopped, the sub cooling process is terminated.

When sub cooling process is terminated, the operation of both the compressor 50 and the fan 20 is stopped, and therefore, the temperature of the storage chambers 40 is not lowered any more. As a result, the temperature of the storage chambers 40 rises after the heat exchange with the evaporator 10 is stopped. However, the refrigerator has an object to keep food in the storage chambers 10 in a cooled state at less than a predetermined temperature. Consequently, when the temperature of the storage chambers exceeds the predetermined temperature, the compressor 50 and the evaporator 10 are operated again to cool the storage chambers 40.

That is, the compressor 50 and the fan 20 are kept stopped until the temperature of the storage chambers 40 of the refrigerator reaches a predetermined limit temperature T_{MAX}. However, when the temperature of the storage chambers 40 reaches a predetermined limit temperature T_{MAX}, the procedure returns to S10. Through the above-described repetition, it is possible to maintain the storage chambers of the refrigerator at a temperature between the limit temperature T_{MAX} and the predetermined temperature Tₘᵢₙ. The less the difference between the limit temperature T_{MAX} and the predetermined temperature Tₘᵢₙ is, the more uniformly food in the storage chambers 40 of the refrigerator is stored in a refrigerated state.

In the control method of the refrigerator according to the present invention, the compression speed of the compressor 50 and the rotation speed of the fan 20 may be electronically controlled.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A refrigerator comprising:
a storage chamber having a storage space defined therein;
a duct partitioned from the storage chamber, the duct being provided at the upper part thereof with a first communication port communicating with the storage chamber, the duct being provided at the lower part thereof with a second communication port communicating with the storage chamber;
an evaporator mounted in the duct;
a fan mounted in the duct for blowing air from the duct into the storage chamber through the first communication port; and
a controller for controlling the operation of the evaporator and the fan.

2. The refrigerator according to claim 1, wherein the fan is configured such that the operation speed of the fan is controllable.

3. The refrigerator according to claim 1, wherein the controller controls the fan to be kept operated for a predetermine time even after the evaporator is stopped.

4. The refrigerator according to claim 3, wherein the controller controls the fan to be operated until the temperature of the evaporator reaches that of the air in the storage chamber.

5. A control method of a refrigerator, comprising:
a main cooling process of operating an evaporator and a fan to blow air in a duct into a storage chamber and cool the interior of the storage chamber; and
a sub cooling process of further operating the fan for a predetermined time, such that the remaining cool air in the evaporator and the duct is introduced into the storage chamber, after the operation of the evaporator is stopped.

6. The control method according to claim 5, wherein the predetermined time of the sub cooling process is time necessary to make the temperature of the evaporator equal to the temperature of air in the storage chamber.

7. The control method according to claim 5, wherein the main cooling process includes a comparison process of comparing the current temperature of the storage chamber with a predetermined temperature of the storage chamber after the operation of the evaporator and the fan is commenced.

8. The control method according to claim 7, wherein the operation of the evaporator at the main cooling process continues until the current temperature of the storage chamber reaches the predetermined temperature of the storage chamber.
